(19) United States
(12) Patent Application Publication
(10) Pub. No.: US 2008/0144696 A1
(43) Pub. Date: Jun. 19, 2008

(54) Heat gun with infrared surface thermometer

(75) Inventors: Daniel Bruggeman, Minneapolis, MN (US); Stephen Kohs, Forest Lake, MN (US)

Correspondence Address: BRIGGS AND MORGAN P.A., 2200 IDS CENTER, 80 SOUTH 8TH ST, MINNEAPOLIS, MN, 55402, US

(73) Assignee: Diversified Dynamics Corporation, Minneapolis, MN (US)

(21) Appl. No.: 11/638,740

(22) Filed: Dec. 13, 2006

(51) Int. Cl. G01J 5/00; G01K 13/00

(52) U.S. Cl. 374/121; 374/141; 374/E13.001

(57) ABSTRACT

A heat gun includes an infrared surface thermometer measuring the surface temperature of a target and a surface temperature indicator readable by an operator of the heat gun, and a nozzle directing heated air at the target. The infrared surface thermometer is pivotally mounted on the heat gun adjacent the nozzle, so as to be aimed at targets at varying distances from the nozzle. The surface temperature indicator is mounted on the heat gun at the end of the heat gun nearest the operator. Optionally, a laser mounted on the thermometer is used to aim the thermometer at the target.

### BACKGROUND OF THE INVENTION

Heat guns, pistol-shaped devices emitting heated air from a “barrel,” are in wide use by homeowners, contractors and the like for defrosting, forming plastics, stripping paint and many other uses. Such heat guns also resemble (in outward appearance and general function) common household hair dryers. However, hair dryers are relatively simple and devoid of temperature regulators.

Such heat guns are used for a variety of purposes, each of which may require (or at least prefer) a different air temperature. For example, paint stripping may require a very high air temperature while plastic forming, especially forming thin sheets or “small-mass” pieces will likely require a more moderate temperature. And, sometimes, the gun is employed solely for its forced air stream with no need for the air to be heated.

Although different air temperatures are required for different tasks, previous heat guns generally did not provide a means of measuring the temperature of the object being heated. Consequently, it was possible to damage the object by using too high a temperature or not performing the desired task, if the temperature is too low.

Infrared surface thermometers can measure the temperature of a target in such fields as electronics, heating and air conditioning, automotive, food, and others. Generally, optics sense emitted, reflected, and transmitted energy which are collected and focused on a detector. The unit's electronics translate the information into a temperature reading displayed on the unit.

Some hair dryers incorporate an infrared radiation sensor which senses the infrared radiation from the hair and thus its temperature. However, such units are designed to operate at temperatures far below those employed in a heat gun (for example, 250 to 1000 degrees Fahrenheit).

There is a need for a heat gun which incorporates an infrared surface thermometer to provide a read-out of the target's temperature to the operator. This will allow the operator to know when the target reaches the desired temperature and to cease heating.

### SUMMARY OF THE INVENTION

A heat gun comprising an infrared surface thermometer measuring the surface temperature of a target and a surface temperature indicator readable by an operator of the heat gun, further comprising a nozzle directing heated air at the target, and wherein the infrared surface thermometer is pivotally mounted on the heat gun adjacent the nozzle, so as to be aimed at targets at varying distances from the nozzle, further comprising a barrel having a first end and a second end, the nozzle being at the first end and the surface temperature indicator being at the second end.

A principal object and advantage of the present invention is that the thermometer is mounted on the heat gun, allowing the use of one hand to control the heat gun and to measure the temperature of the target.

Another principal object and advantage of the present invention is that the thermometer is pivotally mounted, thus allowing the thermometer to be aimed at targets of varying distances from the heat gun.

Another principal object and advantage of the present invention is that it may have a laser mounted on the thermometer to assist in aiming the thermometer at the target.

### BRIEF DESCRIPTION OF DRAWINGS

FIGS. 1A-1C are side elevational views of the heat gun of the present invention.

### DETAILED DESCRIPTION OF THE PREFERRED EMBODIMENT

The present invention is generally shown in the Figures as reference numeral 10.

The present invention is a heat gun 10. The heat gun 10 comprises a barrel 12 having a first end 14 and a second end 16. A nozzle 18 at the first end directs heated air at targets T.

The heat gun 10 further comprises a surface temperature thermometer 20 which measures the surface temperature of the target that is receiving the heated air. An example of such a surface thermometer available on the market is the Cen-Tech Non-Contact Laser Thermometer available from www.harborfreight.com. This is a stand-alone unit with its own surface temperature indicator. The present invention 10 uses technology as exemplified by the above commercial instrument or other similar instruments, but significantly improves on this technology as adapted to a combination with a heat gun.

To achieve these significant improvements, the present invention 10 further comprises mounting the surface temperature thermometer 20 on the heat gun 10 adjacent the nozzle 14 so that the thermometer 20 points at the target T. This improvement permits the operator to measure the surface temperature of the target with only one hand, obviating the need for the use of a stand-alone thermometer held in the operator's other hand. This improvement also permits simultaneous measurement of the surface temperature of the target as heat is directed at the target. Furthermore, the thermometer 20 is outside the heated air stream of the heat gun 10, so that it measures the temperature of the target, not the temperature of the heated air.

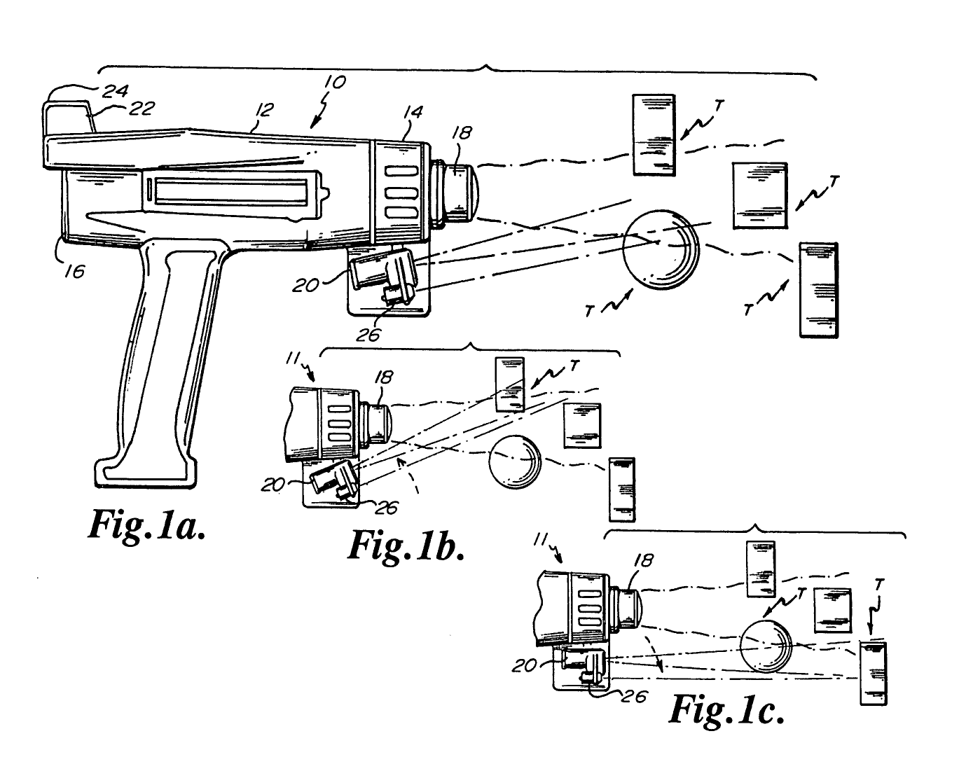

A further improvement is that the thermometer 20 is pivotally mounted adjacent the nozzle 18, so that the thermometer 20 can be aimed at targets at varying distances from the nozzle 18, as shown in FIGS. 1A-1C. The operator may then vary the distance of the nozzle 18 from the target, so as to achieve the desired target temperature.

In another improvement, the surface temperature indicator 22 of the thermometer 20 is placed at the second end 16 of the heat gun 20, nearest the operator, so that the operator may easily view the surface temperature indicator 22 while using the heat gun in normal operation. Preferably, the surface temperature indicator 22 further comprises an LED 24, or series of LEDs. Such LEDs may be arranged in any manner to indicate a temperature within a desired range, as for example, but not inclusive thereof, using LEDs of different colors (not shown). Alternatively, or in addition thereto, the LEDs may be arranged along a temperature scale (not shown) so that they are suitably lit according to the temperature of the target.

Optionally, the heat gun 10 may further comprise a laser 26 to assist in aiming the thermometer 20 at the target. For best results, the laser 26 is mounted on the thermometer 20 so that the laser 26 pivots with the thermometer 20.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described below. All publications, patent applications, patents, and other references mentioned herein are incorporated by reference in their entirety to the extent allowed by applicable law and regulations. In case of conflict, the present specification, including definitions, will control.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention.

1. A heat gun comprising an infrared surface thermometer measuring the surface temperature of a target and a surface temperature indicator readable by an operator of the heat gun, wherein the infrared surface thermometer is able to measure temperatures of at least 250 degrees F.

2. The heat gun of claim 1, further comprising a nozzle directing heated air at the target, and wherein the infrared surface thermometer is mounted on the heat gun adjacent the nozzle.

3. The heat gun of claim 2, wherein the infrared surface thermometer is adjustable for measuring the temperature of targets at varying distances from the nozzle.

4. The heat gun of claim 3, wherein the infrared surface thermometer is pivotally mounted on the heat gun so as to be aimed at targets at varying distances from the nozzle.

5. The heat gun of claim 1, wherein the surface temperature indicator further comprises at least one light-emitting diode.

6. The heat gun of claim 2, further comprising a barrel having a first end and a second end, the nozzle being at the first end and the surface temperature indicator being at the second end.

7. The heat gun of claim 4, further comprising a laser to aim the infrared thermometer at the target.

8. The heat gun of claim 7, wherein the laser is mounted on the infrared thermometer.

9. A heat gun comprising a barrel having a first end and a second end, an infrared surface thermometer measuring the surface temperature of a target and a surface temperature indicator readable by an operator of the heat gull, further comprising a nozzle at the first end directing heated air at the target, and wherein the infrared surface thermometer is mounted on the heat gun adjacent the nozzle, and wherein the surface temperature indicator is mounted on the heat gun at the second end.

10. The heat gun of claim 9, wherein the infrared surface thermometer is adjustable for measuring the temperature of targets at varying distances from the nozzle.

11. The heat gun of claim 10, wherein the infrared surface thermometer is pivotally mounted on the heat gun so as to be aimed at targets at varying distances from the nozzle.

12. The heat gun of claim 9, wherein the surface temperature indicator further comprises at least one light-emitting diode.

13. (canceled)

14. The heat gun of claim 11, further comprising a laser to aim the infrared thermometer at the target.

15. The heat gun of claim 14, wherein the laser is mounted on the infrared thermometer.

16. A heat gun comprising an infrared surface thermometer measuring the surface temperature of a target and a surface temperature indicator readable by an operator of the heat gun, further comprising a nozzle directing heated air at the target, and wherein the infrared surface thermometer is pivotally mounted on the heat gun adjacent the nozzle, so as to be aimed at targets at varying distances from the nozzle, further comprising a barrel having a first end and a second end, the nozzle being at the first end and the surface temperature indicator being at the second end.

17. The heat gun of claim 16, wherein the surface temperature indicator further comprises at least one light-emitting diode.

18. The heat gun of claim 16, further comprising a laser to aim the infrared thermometer at the target.

19. The heat gun of claim 18, wherein the laser is mounted on the infrared thermometer.

20. The heat gun of claim 1, wherein the thermometer is capable of measuring a temperature in a range of 250 degrees F. to 1000 degrees F.
